(19) United States
(12) Patent Application Publication
(10) Pub. No.: US 2011/0011141 A1
(43) Pub. Date: Jan. 20, 2011

(54) METHOD FOR TREATMENT OF OIL AND/OR GAS FIELD WASTE AND BY PRODUCT MATERIALS

(75) Inventors: Maureen B. Hepburn, Aberdeenshire (GB); John A. Smith, Hatton (GB); Allister J. W. Phillips, East Lothian (GB); Vernon De Jager, Aberdeen (GB)

Correspondence Address: IP GROUP OF DLA PIPER LLP (US), ONE LIBERTY PLACE, 1650 MARKET ST, SUITE 4900, PHILADELPHIA, PA, 19103, US

(73) Assignee: Envireneer R&D Limited, Aberdeen (GB)

(21) Appl. No.: 12/303,774

(22) PCT Filed: Jun. 11, 2007
(86) PCT No.: PCT/GB07/02153

§ 371 Date: Nov. 13, 2009

(30) Foreign Application Priority Data
Jun. 9, 2006 (GB) 0611391.4
Dec. 22, 2006 (GB) 0625782.8
Mar. 1, 2007 (GB) 0703960.5

(51) Int. Cl. C05F 11/08; A62D 3/02

(52) U.S. Cl. 71/8; 435/262.5

(57) ABSTRACT

A method for the treatment of oil and/or gas field waste and by product materials, the method comprising composting the waste materials. The present invention is typically suited to the treatment of waste and by-product materials from oil and gas wells that are contaminated by organic compounds, such as hydrocarbon residues, either from oil based drilling muds, or from hydrocarbons produced from the well. The composting is typically accomplished by an endogenous microbial population on the composted mixture, and optionally a feeder material to provide N and C sources for the microbes. The composting operation is typically carried out in a composting chamber, and typically an auger or some other tilling device is used to mix the material within the composting chamber.

### CROSS REFERENCE TO RELATED APPLICATIONS

This application is a §371 of International Application No. PCT/GB2007/002153, with an international filing date of Jun. 11, 2007 (WO 2007/141556 A1, published Dec. 13, 2007), which claims priority of British Patent Application No. 0611391.4, filed Jun. 9, 2006, British Patent Application No. 0625782.8, filed Dec. 22, 2006 and British Patent Application No. 0703960.5, filed Mar. 1, 2007, the subject matter of which is herein incorporated by reference.

This invention relates to a method of treatment of material, particularly the treatment of waste and by-product material such as organic and inorganic hydrocarbon waste generated in the drilling and operation of oil and gas wells.

Waste and by-product materials from oil and gas wells are typically contaminated by crude residues from the well itself, or from oil-based and water based drilling muds used in the drilling process. For example, during the drilling phase of each well, small pieces of the rock being drilled are chipped away by the drill bit at the end of the drill string. These are generally known as cuttings or drill cuttings in the art. The drill cuttings are washed up the borehole away from the drill bit by drilling mud, and are recovered at the surface where considerable effort is expended in the separation of the drilling mud from the cuttings. Separation of the drill cuttings from the contaminating mud and the residual hydrocarbons that permeate the drill cuttings is important for several reasons. The drilling mud is a highly engineered fluid that is expensive, and recycling it back into the well to recover additional drill cuttings has economic benefits. In addition, it is environmentally unacceptable to dump waste and by-products contaminated with either the exogenous drilling mud, or the indigenous hydrocarbons produced from the well, so before the drilling wastes and by-products can be disposed of properly, the levels of contaminating organic and inorganic compounds (from production fluids and drilling mud) need to be reduced to acceptable levels.

Current solutions to this problem are generally related to stringent separation procedures in shale shakers and the like, to physically separate the cuttings from the contaminating hydrocarbon fluids, after which, the cuttings are usually dumped at sea, or sent to landfill.

In accordance with the present invention there is provided a method for the treatment of oil and/or gas field waste and by product materials, the method comprising composting the waste material, wherein the composting operation is carried out in a composting chamber.

The present invention is typically suited to the treatment of waste and by-product materials from oil and gas wells that are contaminated by organic compounds, such as hydrocarbon residues, either from oil, water or synthetic based drilling muds, or from hydrocarbons produced from the well. Embodiments of the invention are also suitable for the treatment of wastes and by-products having inorganic contamination, such as sulphates, chlorides, formates and heavy metals. Other embodiments of the invention are suitable for reducing contamination in other waste materials, such as biological waste, for example, animal waste from slaughterhouses, or food wastes from factories.

The composting is typically accomplished by an endogenous microbial population on the composted mixture, which may also comprise a feeder material to provide N and C sources for the microbes, as well as the contaminated waste or by-product material to be treated.

The microbes typically degrade or consume the contamination on the waste or by-product materials being treated and use these contaminating compounds as metabolic substrates for their normal life cycle. The contaminating products can typically come from inorganic or organic drilling muds, and can supply substrate compounds that may be used in microbial metabolism, such as glycol, sulphates, chloride salts, sodium formate, KCI, NaCl, Barium and other constituents of drilling muds.

The feeder material can comprise biological material that is high in carbon sources such as fruit and vegetable waste, bark and twigs, sawdust, shavings and chipped wood, shredded paper and cardboard. The waste material can comprise biological material that is high in N sources such as plant waste, leaves, grass and plant cuttings and green sawdust. Typically, the biological material provides a nitrogen source and a carbon source for the composting operations. A good source of nitrogen for the composting operations is manure and frequently the biological feeder materials can comprise animal bedding, for example, hen pen (a mixture of chicken manure and wood shavings, wood chips and sawdust, gathered from the floor of hen houses), pig pen, fish waste gathered from fish factories and other plant or animal sources of nitrogenous waste material.

Typically, the waste products are contaminated by organic residues, and most typically the hydrocarbon-contaminated waste products contain long-chain carbon residues. Typical chain lengths exceed five carbon atoms, and particularly more than ten carbon atoms. For example, C₁₂ to C₁₈ carbon chains are suitable for treatment by the method. Up to C₃₀, for example C₂₄ to C₂₈, is also treatable using the present invention. Shorter chain hydrocarbons can also be treated, for example between 5 and 10 carbon atoms. Longer chain hydrocarbons can be treated with the method of the invention. For example, very long chain hydrocarbons having chain lengths of 50-100 even of several hundred carbon atoms, e.g. 500-1000 carbon atoms, can be effectively treated by the method of the invention.

The composting generally makes use of the indigenous flora of microbes present on the waste and feeder material being treated in order to perform the composting operation, but in certain embodiments of the invention, an exogenous source of microbes can be added to the composting mix in order to degrade particular contaminants on the waste or by-product material. Typically, the microbial flora (indigenous or exogenous) can be thermophilic hydrocarbon degraders such as Bacillus SP, Pseudomonas SP and Amycolata SP. Additional useful microbial flora include Promicromonospora SP, Microbacterium barkeri, Rhodococcus globerulus, Geobacillus pallidus and Gebacillus subterraneus. The following microbial flora deposited in NCIMB are suitable for carrying out the invention.

| Species | Deposit number, date |
|---|---|
| Promicromonospora enterophila | NCIMB618, 01/01/1959 |
| Promicromonospora sp | NCIMB30194, 04/09/2006 |
| Promicromonospora citrea | NCIMB10170, 16/02/1968 |
| | NCIMB12149, 03/09/1985 |
| | NCIMB12920, 27/09/1989 |
| | NCIMB12921, 27/09/1989 |
| Microbacterium barkeri | NCIMB9658, 03/03/1965 |
| | NCIMB702301, 01/01/1980 |
| | NCIMB30193, 04/09/2006 |
| Rhodococcus globerulus | NCIMB12315, 04/08/1986 |
| | NCIMB30195, 04/09/2006 |
| Geobacillus pallidus | NCIMB41468, 04/09/2006 |
| | NCIMB41469, 04/09/2006 |
| Geobacillus subterraneus | NCIMB13892, 29/04/2002 |
| | NCIMB30191, 04/09/2006 |
| | NCIMB30192, 04/09/2006 |

Thermophilic hydrocarbon degraders are good options, because they can withstand higher temperatures during the composting operation, but other microbes might degrade and metabolise particular contaminants more effectively than others, and could be added if desired.

A nutrient may be added during the composting reaction to aid bacterial growth and help establish the dominant bacterial species within the reaction, for example, by introduction of a liquid or use of a spray.

In typical embodiments of the invention, the exogenous feeder materials added are carefully controlled to encourage the microbial flora in the composting mix to break down the contaminants (e.g. the long chain hydrocarbons) on the waste and by-product material rather than the short chain carbon residues in the feeder material. Therefore, feeder materials with a high nitrogen content are preferred.

An exogenous carbon source from the feeder material is also useful to provide an initial boost to the microbial population in order to achieve a population suitable for effective degradation of the longer chain hydrocarbon contaminants present on the waste material being treated. Therefore, a balance of the high —C and high —N feeder materials is typically maintained throughout the composting operation to control the available amounts of carbon from the feeder material and the waste material. Fruit and vegetable material is a useful feeder material for initiating the composting procedure, and is typically added to the initial mix in order to raise the composting microbes to the desired levels of population and activity.

In some embodiments bulky plant material (such as wood chippings) is added not only to provide an additional carbon source for the microbes, but also to provide a support matrix for the composting method. The bulky wood chippings and the like create many air spaces between them and enhance aeration in the mixture, and also promote microbial mobility within the mixture.

Aeration and agitation can also be carried out by injection of compressed gasses into the reaction mixture, for example compressed air. The injected gas can be heated or cooled to the ambient temperature of the mixture before injection if desired. Injection of compressed air enhances the aeration by physically agitating the mixture, and by circulating more air within the reaction chamber.

Typically, the feeder material is shredded before being mixed with the waste material being treated.

The material being composting is typically agitated during the process. The agitation is typically achieved by an agitatation device, e.g. an auger or some other tilling device, which moves, lifts, mixes or otherwise agitates the material within the composting chamber. The chamber is typically cylindrical and the agitation device, e.g. an auger or other tilling device, typically has blades that extend across the whole diameter of the cylinder. The chamber is preferably sealed or covered. Other shapes of chamber are suitable, such as those with square or rectangular cross-sections. An elongate chamber is preferred. Use of the chamber facilitates the composting mixture to reach a critical mass at which point the composting reaction becomes self-sustaining.

The agitation device, for example the auger, typically moves, lifts, mixes or otherwise agitates the material being composted and ensures sufficient aeration during the composting process so that the microbial population has improved access to the contaminants from the material being composted, and so that substantially all of the contaminants in the mixture are aerobically degraded by the microbial population. The auger can be set to rotate continuously at a very slow rate (e.g. 1 or 2 rpm) or to turn the material being composted intermittently during the process, for example to operate one or two revolutions or a fraction of one revolution (each movement lasting for a short period such as one or two minutes) once or twice every hour or so during the composting process.

The chamber can be horizontal, but in some embodiments it can be arranged with its central axis oriented upwards, either inclined slightly or vertical, so that the material being composted falls to the bottom of the chamber, and is lifted by the tilling device towards the top of the chamber. The composted material can typically be withdrawn from the base of the chamber and new material can typically be fed into the top.

Generally, the composting process is carried out at between 40 C and 80 C, and ideally between 50 C and 75 C, e.g. 60 C. The particular temperature profile can be controlled by heating and cooling units in the composting chamber to maintain the temperature within a set range that is beneficial for the microbial population being used in the process.

The material being treated is typically drill cuttings, but oil field slops and other waste materials generated during the drilling and production of oil and gas wells can also be treated in the invention.

Embodiments of the present invention can optionally remove the need to pre-treat or pre-wash the cuttings to remove, reduce or alter salt contaminants. Salts present on the cuttings can instead be utilised as part of the composting reaction and improve and aid the composting reaction. Thus, typically, no additional chemicals are needed to be into the composting process, thus reducing costs.

Typically the contaminated material can be passed through the process more than once, particularly if the levels of contamination after the first pass are still high. Typically material is processed for a second time shortly after its first pass, when the microbial population within the first pass output material is still active. After processing for one or two passes through the composting chamber, the output material can be used straight away or advantageously can be left to mature in static piles to enable fungi to break down complex hydrocarbons such as phenyls and reduce the remaining available hydrocarbons.

The invention also provides a method of producing compost, the method comprising adding oil field waste materials (typically drill cuttings) to a composting mixture so that the microbial population in the composting mixture degrades metabolic substrates on the oil field waste materials.

An embodiment of the present invention will now be described by way of the following examples:

### EXAMPLE 1

A composting mixture was prepared comprising a feeder material with nitrogen and carbon sources. The N source comprised hen pen. The carbon source comprised green waste from agricultural, horticultural gardening activities such as grass cuttings, forestry limbs, pine needles and leaves, and a mixture of waste fruit and vegetable material obtained from local supermarkets. The precise composition of the waste fruit and vegetable material was not important, but typically starchy vegetables like potatoes, cauliflower, bananas etc are useful as well as leafy materials such as cabbage, lettuce and brussel sprouts. The fruit and vegetable waste can be cooked or uncooked, and serves as an initiator to provide bio-available carbon for boosting the growth of microbial flora present in the composting mixture. The green waste from agricultural, horticultural and gardening activities also provides a good source of carbon, whereas the hen pen is added as a nitrogen source. To these three components was optionally added a quantity of oversized returns from earlier composting runs.

The oversized returns typically comprise large and small branches and wood chips that exceed particular size criteria. They are re-added to the composting mixture as a filler or bulking agent in order to keep the mixture aerated, and to supply additional surface area for the growth of the microbial population.

The initial mixture was made up with the fruit and vegetable waste to act as an initiator, and was added to a composting chamber where it was left to compost until the temperature had risen to a steady 50-65 C and other indicators of composting activity were apparent from the output material being sampled. For example, when the output/input mass ratio fell to around 60-80% this indicated that composting activity was degrading material within the chamber. Also, particle size distribution in the output material was sampled periodically to gauge the extent of composting activity; generally, when the particle size distribution dropped, for example below an average of 12 mm, this tended to indicate that the composting activity was under way. The achievement of a satisfactory and stable level of composting activity took different periods with different substrates but generally, this was achieved after a period of around 7-14 days with programmed occasional turning by an auger device. The auger performed one partial (120 degree) revolution (lasting 3 to 5 minutes) every 45 minutes, and served to aerate the mixture during the composting process. The composting chamber comprised an elongate tubular chamber with a radial inlet tube at one end, and an axial outlet at the other. The tube is typically mounted on a frame at an angle so that as the material is composted and moved within the tube by the auger from the inlet to the outlet, the material moves up the slope from the inlet to the outlet, until it falls from the outlet for collection. The collected material from the outlets can be sieved for extraction of oversized returns.

After the mixture had been composting for 10-14 days or when the temperature had reached a steady state of between 50-65 C, a test material was added consisting of oil well cuttings that were contaminated by drilling mud. Suitable test materials also include oil field waste slops and drill cuttings contaminated by production fluids from the well. In this example, the test material was added only after the composting process was judged to be under way, and the carbon source provided by the fruit and vegetable waste for the initial start up procedure was judged to be well consumed. After the addition of the test material no further fruit and vegetable waste material was added, and in certain embodiments of the invention, the fruit and vegetable waste material can be omitted entirely, although it is useful to boost the microbial population at an initial phase of the composting procedure, before the introduction of the test material with the long chain hydrocarbons.

The compost mixture was left to compost in the chamber along with the test material for 3-10 days until the contaminating hydrocarbons in the material ejected from the outlet at the composting chamber had reduced to acceptable levels. The output material was optionally re-introduced into the inlet if it was still contaminated. Table 10 shows a flowchart giving general and schematic details of the process used for example 1. Table 1 shows the amounts of materials used in example 1, and the amount of composted product generated.

### EXAMPLE 2

The materials shown in table 2 were used in the same way for example 2, with slightly more oversized returns and slightly less test material.

The mixture was initially run with fruit and vegetable waste added as an initiator, and the test material added only after the depletion of the fruit and vegetable waste by the indigenous microbial flora. The temperature was monitored during the run and maintained within the range of 40 C to 60 C. If the mixture showed any signs of cooling down the aeration was increased by increasing the tilling, or additional water (or occasionally a Nitrogen source such as hen pen) was added with the next batch of input material in order to maintain the microbial population at a consistently optimal level.

During example 2, heat pads were used in the composting chamber to maintain the temperature within the desired range. Table 2 shows the amounts of materials used in example 2, and the amount of composted product generated.

### EXAMPLE 3

Example 3 was run in the same way as the earlier examples, but with a larger volume of test material, and a smaller proportion of fruit and vegetable waste. The larger component of test materials included a fluid component of 125 litres of condensates or fresh water that was added to the composting mixture during the process in order to increase the moisture content of the material in the chamber. Table 3 shows the amounts of materials used in example 3, and the amount of composted product generated.

### EXAMPLE 4

During example 4, no fruit and vegetable waste was used, and the run was initiated using the test material, the hen pen and green waste. Additional carbon sources optionally provided included chipped wood and brown bark in the mixture. The brown bark was added as a bulking/filler agent in place of the oversized returns used in earlier examples. This was due to a change in available raw materials, and illustrates that the method can be carried out using various different raw materials, according to seasonal and regional variations in availability. Table 4 shows the amounts of materials used in example 4, and the amount of composted product generated.

### EXAMPLE 5

Example 5 was also run without added fruit and vegetable waste materials. Chipped wood was also added as a filler material, and the test material included 4 litres of water to assist with the formation of biofilms on the surfaces of the materials. Table 5 shows the amounts of materials used in example 5, and the amount of composted product generated.

### EXAMPLE 6

Example 6 was run in the same way to example 5 using slightly different amounts of test material. Table 6 shows the amounts of materials used in example 6, and the amount of composted product generated.

### EXAMPLE 7

Example 7 used the same base formulations used for examples 5 & 6 but using different amounts of nitrogen sources, test material, water and activator. The increased fluidic content aided in enhancing the biofilm formation across all the open surfaces. The test material used included returns from earlier treatment runs. Table 7 shows the amounts of materials used in example 7, and the amount of composted product generated.

### EXAMPLE 8

This example used the same ratios of materials as in example 5. However, there was a reduction in nitrogen content in the input material and brown bark was added to maintain sufficient air spaces within the blended materials. The volumes of activator and water were also increased, mainly to increase the biofilm establishment and maintain equilibrium. Table 8 shows the amounts of materials used in example 8, and the amount of composted product generated.

### EXAMPLE 9

Example 9 used the same base formulation as for example 7, but with an increased water volume added to the blended materials. The input material for example 9 included returns from earlier treatment runs. Table 9 shows the amounts of materials used in example 9, and the amount of composted product generated.

In all of the above examples the mixture optionally included an activator comprising a mixture of amino acids and nutrients to serve as precursors for use in the metabolic pathways employed by the microbial population. The typical composition of the activators used included amines, amino acids, purines, pyrimadines, sarsoponin, saponin, carbohydrates, surfactants, nitrates, trace amounts of sulphates of cobalt, copper, dihydrogen, iron, magnesium, manganese, zinc and other minerals.

The composting chamber in all of the above examples was a 300-litre that was typically maintained at 40 C to 75 C. The output from the composting chamber was measured and was typically of the order of 40 to 50 litres of solid materials ejected from the outlet each day and varying volumes (e.g. up to a few mls of leachate every day of leachate and condensate per day. The leachate and condensate was optionally reintroduced into the chamber after recovery in order to increase the moisture content in the material being treated and/or to process the leachate by a further round of composting treatment. The re-introduction of the leachate into subsequent passes was useful since it boosted the microbial population.

Typically, the materials inserted into the composting chamber were blended into a homogenous mixture of green waste, hen pen, oversized returns-and fruit and vegetable waste etc along with the activator used. Typically, this mixture was then blended homogenously with the drill cuttings or other material to be treated in a ratio of around 10 to 35% of test material by weight. Around 60 kg was then loaded into the reactor and the composting chamber was then allowed to progress over 2 to 5 hours until the operating temperature of the composting chamber reached the target range. After the temperature had reached the target range between 40 C and 75 C, the input-mix, the rate of turning and the temperature of the heat pads was then controlled in order to maintain that range. Addition of more input material would result in cooling, and increases in rate of turning would also result in cooling in some instances, because the dense materials forming piles within the composting chambers would keep the heat within the piles, which was disturbed and released by any increase in turning rate. Typical rates of turning were one turn of 120 degree rotation of an auger blade every 45 minutes.

The output materials were monitored to provide an indication of the progress of the reaction. A condenser was provided to condense the gasses liberated from the mixture into different phases, optionally to separate oily fractions with low boiling points from lighter fractions with higher boiling points. Conventional dehumidifiers optionally worked well with early prototypes of the system. Generally, the volume of liquid condensed from the reaction chamber was taken as an indication of the rate of respiration of the microbes. Low volumes of condensed fluid indicated that the microbes were not in a rapid phase of growth. If the volume of condensate recovered, or the core temperature, dropped below a certain range, the amount of fruit and vegetable waste within the composting chamber was optionally temporarily increased to boost the accessible carbon source to the microbes and increase their growth rate. Alternatively, the rate of turning was increased or the amount of oversized materials was increased in order to improve the aeration of the reaction. In the case of temperature increases above 70°, the heat pads were switched off, or additional fluid was added to the system.

### RESULTS AND DISCUSSION

Table 11 lists the example number together with the main findings for that example. Table 12 summarises the hydrocarbon levels for the different examples.

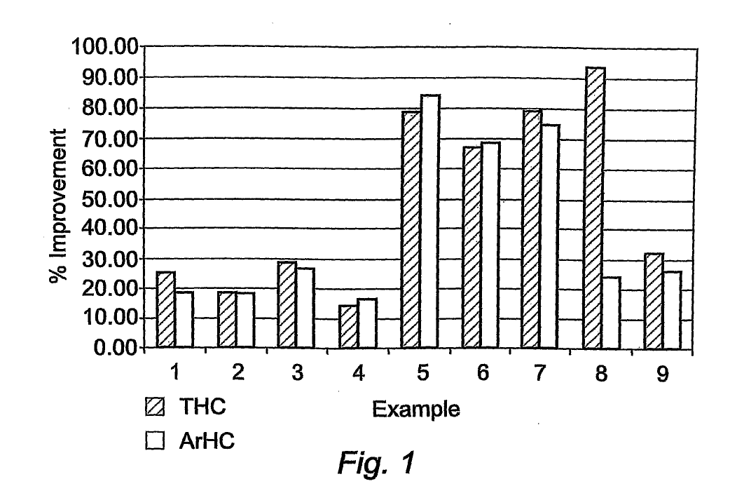

FIG. 1 shows a graph of the percentage improvement in hydrocarbons data from table 12. In FIG. 1 and table 12, THC=total hydrocarbon content, and ArHC=Aromatic hydrocarbon content. It can be seen that trials 5, 7 and 8, result in the best improvements in hydrocarbon levels in the output material. Analysis of output material acquired from Examples 1 and 2, which had the highest percentage of hydrocarbons in the input material, demonstrated that the total amount of polychlorinated biphenyls and polycondensed aromatic hydrocarbons had been reduced to less than 0.001 and 0.01% respectively of the total output material. This correlates to the output material containing less than 20000 ppm hydrocarbons, and in some instances as low as 1000 ppm of hydrocarbons in the compost.

Worldwide standards for residual hydrocarbons vary but the most stringent typically require levels to contain less than 5% hydrocarbon material. More stringent EU and UK standards dictate a maximum value of 0.5 percent. As such the compost generated by the methods can be used as a non-hazardous product worldwide.

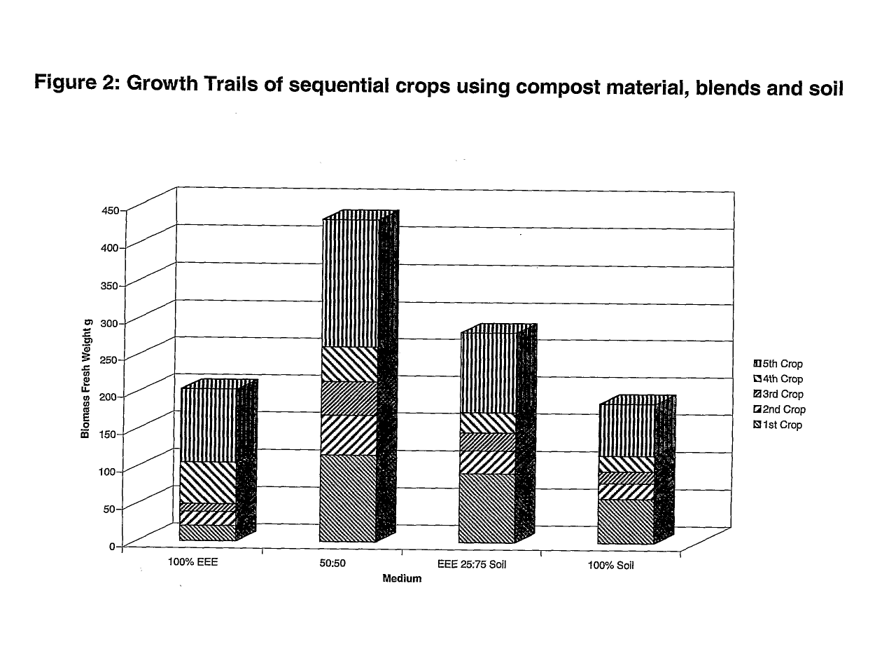

One advantageous benefit of the treatment process was the microbiological breakdown of the oils to produce a compost product fit for use in the environment. To demonstrate the improvement over soil, growth trials were undertaken and the findings are shown in FIG. 2. From the data presented in FIG. 2, it can be seen that the composted output material from example 7 above is seen to provide a substantial improvement over soil when at 50:50 & 25:75 compost: soil blends.

Further growth trials using the output material from Example 7 are shown in Table 13. Crops grown with 100% soil, 100% compost, 50:50 or 25:75 blends of compost: soil consistently demonstrated significantly higher growth of plants when the blends were used. FIG. 2 shows the graph of the Table 13 data. Biomass was assessed periodically by cropping and then weighing the cropped grass. Aggregated results are given in table 13 showing the various growth responses for the product, its blends with local natural soils, and with the natural soils themselves.

Output material blended at a ratio of 50:50 or 25:75 with garden soil supported enhanced plant growth relative to the plant growth seen with garden soil alone. The 50:50 provided an approximate 100% to 150% increase in plant growth and the 25:75 blend produced approximately 35% to 50% increase in plant growth. Due to high nutrient levels in the 100% compost, it saw initial poor germination and plant growth, but by the end of the growth trial, plant growth supported by 100% output material had exceeded that seen from 100% soil.

Vegetative cover was thickest for the 50:50 and 25:75 blends clearly demonstrating the nutritional benefit of the compost addition to the local soils.

The data therefore demonstrates that although 100% output material can be used to enhance plant growth relative to that gained from soil alone, blends of the output material and soil can achieve better growth and coverage.

The output material and associated blends from Example 7 were assessed for compliance with commercial soil standards relating to the presence of potentially toxic elements (PTEs). Tables 14 and 15 show this data. In Table 14, figures are restated to 30% or 40% organic matter (OM) in accordance with SEPA and EU standards. The output material and blends complied with the UK publicly acceptable standards (PAS 100), the contaminated land exposure agreement assessment guidelines (CLEA), the Scottish Environment Protection Agency (SEPA) standard and draft EU biowaste standards. These standards are designed for use with materials suited for horticulture, landscaping, land remediation and soil manufacturer activities. Table 14 further compares the average compost results taken from numerous batches and the results obtained for one individual trial batch of compost material. Table 15 further shows the CLEA commercial and industrial limits for PTEs.

To further assess the output material, plant uptake of PTEs present was also assessed using grasses as the sample crop. Biomass from crop sets for each growth medium was dried, aggregated and analysed for PTE uptake. Table 16 shows the results of the analysis and compares the presence of elements in the compost material used to grow the crops against the amount taken up by the crop. The degree of PTE uptake in grasses grown on the output material and blends are similar to those for grasses grown on soil alone, and for some (e.g. Cr and Ni) the uptake into grasses grown on output material product was less.

Normal levels for plants, and harvest-related toxicity limits for cereal crops are quoted in Table 17 which compares the levels of PTE uptake by plants against the common EU guidelines. Thus the assessment of plant uptake of PTE indicates no potential hazard, and risks to any grazing animals are minimal. The levels of PTE in both product and its blends conforms to the most rigorous of CLEA limits and indicates that any potential risk to humans is also insignificant.

The ability of PTEs present in the output material to leach out was assessed. Table 18 shows the results of PTEs present in leachate compared to the drinking water standards (SS=suspended solids; E. cond=electrical conductivity of the leachate; BOD=biological oxygen demand). Downflow data represent water passed downward through a column of output material, blend or soil, the water being passed through the matter. Thus, downflow assessment simulates the effect of rainfall. Upflow data represents water allowed to pass upwards through columns of the material and represents the effect of water pooling in combination with the output material, for example as would be expected in regions close to rivers or other bodies of water.

The data in Table 18 demonstrates that the leachate generated by waters passing through the output material and its blends are chemically benign with respect to PTEs.

Use of a chamber facilitates the reaching of a critical mass of the composting mixture after which the composting reaction can more easily become self-sustaining. In this state, the internal temperature of the chamber is typically maintained at least at a minimum temperature required-for bacterial activity and the composting reaction can continue with a reduced requirement for alteration of environmental conditions.

Using the formulation of example 7, a typical average initial input material of approximately 95 Kg/1270 L is supplemented for 10 to 16 days, e.g. preferably 13, 14 or 15 days, by a daily input of material of approximately 19 Kg/54 L. Typically, the composting mixture requires approximately 5 to 8 days to become self-sustaining, with output compost material being generated within a further 1 to 5 days, normally, 2 or 3 days. Optimally, and to ensure a stable reaction is achieved, 20% or more additional material, optionally 25%, may be used over those required to reach critical mass.

The above conditions are not absolute requirements in order to achieve critical mass. Altering the conditions (e.g. temperature, moisture, microbiological agents etc) and formulation (e.g. presence of activators, percentage of organic matter etc) will affect the amount of initial input material, the amount of further input material and the time taken to reach a self-sustaining reaction. Further, use of different sized composting chambers will have different maximum load capabilities and differing abilities to maintain the temperature within the chamber. As such, the size of the chamber can be expected to also affect the time taken to reach critical mass needed to arrive at a self-sustaining reaction. Using different formulations and also the time of year in which the composting reaction takes place can also affect the conditions required to reach critical mass.

In certain embodiments, the aeration of the reaction could be improved by injecting compressed air warmed or cooled to local conditions (or other gasses such as oxygen) into the composting mixture in order to mix the composting mixture and also provide additional oxygen for microbial respiration. Strategic use of the agitation device, e.g. an auger or tilling device, also allows control over the introduction of oxygen into the reaction mixture, ensuring that the oxygen does not cool the reaction mixture temperature and improves output material quality.

A typical composting mixture might contain 20-40% green waste, 20-40% oversized return or bulking agent, 10-30% nitrogen source such as hen pen, and 10% to 20% of contaminated test material or fruit and vegetable waste.

In certain embodiments, additional contaminating hydrocarbons can be added into the mixture in order to increase the available carbon sources for growth of the microbial population.

In certain embodiments the hydrocarbons can be driven off by thermal evaporation from the heat generated by the composting process, and removed from the reaction mixture by condensation, thereby reducing the effect of catabolyte repression on the production of hydrocarbon degrading enzymes by the microbes.

After the treatment within the composting chamber, the treated material can be left in a static pile for white rot fungi to establish and break down complex hydrocarbon residues (such as phenyls).

Modifications and improvements can be incorporated without departing from the scope of the invention.

TABLE 1
Test Unit 01, Example 1

| | SOLID MATERIALS ADDED | | | | | | | | | |
|---|---|---|---|---|---|---|---|---|---|---|
| | Fruit/Veg | | HenPen | | Green Waste | | Oversized Return | | Test Mat. | |
| Item | Vol. Lts | Wt. Kg | Vol. Lts | Wt. Kg | Vol. Lts | Wt. Kg | Vol. Lts | Wt. Kg | Vol. Lts | Wt. Kg |
| Sheet Value | 336 | 136.19 | 336 | 155.16 | 672 | 183.80 | 672 | 255.30 | 196 | 318.01 |
| Input | 15.19 | | 15.19 | | 30.38 | | 30.38 | | 8.86 | |
| % Volume | | | | | | | | | | |
| Input | | 12.99 | | 14.80 | | 17.53 | | 24.35 | | 30.33 |
| % Weight | | | | | | | | | | |

| | SOLID MATERIALS ADDED | | | | | |
|---|---|---|---|---|---|---|
| | CUMULATIVE | | ACTIVATOR | | PRODUCT | |
| Item | Vol. Lts | Wt. Kg | Description | Vol. Lts | Vol. Lts | Wt. Kg |
| Sheet Value | 2212.00 | 1048.46 | | 11 | 1513 | 673.81 |
| Input | 100 | | | | | |
| % Volume | | | | | | |
| Input | 100 | | | | | |
| % Weight | | | | | | |

TABLE 2
Test Unit 02, Example 2

| | SOLID MATERIALS ADDED | | | | | | | | | |
|---|---|---|---|---|---|---|---|---|---|---|
| | Fruit/Veg | | HenPen | | Green Waste | | Oversized Return | | Test Mat. | |
| Item | Vol. Lts | Wt. Kg | Vol. Lts | Wt. Kg | Vol. Lts | Wt. Kg | Vol. Lts | Wt. Kg | Vol. Lts | Wt. Kg |
| Sheet Value | 336 | 136.38 | 336 | 162.61 | 672 | 166.68 | 720 | 268.94 | 164.5 | 285.35 |
| Input | 15.08 | | 15.08 | | 30.15 | | 32.31 | | 7.38 | |
| % Volume | | | | | | | | | | |
| Input | | 13.37 | | 15.94 | | 16.34 | | 26.37 | | 27.98 |
| % Weight | | | | | | | | | | |

| | SOLID MATERIALS ADDED | | | | | |
|---|---|---|---|---|---|---|
| | CUMULATIVE | | ACTIVATOR | | PRODUCT | |
| Item | Vol. Lts | Wt. Kg | Description | Vol. Lts | Vol. Lts | Wt. Kg |
| Sheet Value | 2228.5 | 1019.96 | | 11 | 864 | 440.24 |
| Input | 100 | | | | | |
| % Volume | | | | | | |
| Input | 100 | | | | | |
| % Weight | | | | | | |

TABLE 3
Test Unit 01, Example 3

| | SOLID MATERIALS ADDED | | | | | | | | | | | |
|---|---|---|---|---|---|---|---|---|---|---|---|---|
| | | | | | | | Chipped | | | | | |
| | Fruit/Veg | | HenPen | | Green Waste | | Wood | | Test Mat. | | CUMULATIVE | |
| | Vol. | | Vol. | | Vol. | | Vol. | | Vol. | | Vol. | |
| Item | Lts | Wt. Kg | Lts | Wt. Kg | Lts | Wt. Kg | Lts | Wt. Kg | Lts | Wt. Kg | Lts | Wt. Kg |
| Sheet Value | 276 | 81.77 | 276 | 142.60 | 276 | 68.71 | 276 | 92.86 | 828 | 357.01 | 1932.00 | 742.95 |
| Input | 14.29 | | 14.29 | | 14.29 | | 14.29 | | 42.86 | | 100 | |
| % Volume | | | | | | | | | | | | |
| Input | | 11.01 | | 19.19 | | 9.25 | | 12.50 | | 48.05 | 100 | |
| % Weight | | | | | | | | | | | | |

| | LIQUID ADDITIONS | | | ACTIVATOR | | PRODUCT | |
|---|---|---|---|---|---|---|---|
| | Leach. | Cond. | Fresh | | Vol. | Vol. | |
| Item | Vol. Lts | Vol. Lts | Vol. Lts | Description | Lts | Lts | Wt. Kg |
| Sheet Value | 0 | 0 | 125 | | 9.2 | 994 | 476.25 |
| Input | | | | | | | |
| % Volume | | | | | | | |
| Input | | | | | | | |
| % Weight | | | | | | | |

TABLE 4
Test Unit 02, Example 4

| | SOLID MATERIALS ADDED | | | | | | | | | | | |
|---|---|---|---|---|---|---|---|---|---|---|---|---|
| | | | | | Green | | Chipped | | | | | |
| | Fruit/Veg | | HenPen | | Waste | | Wood | | Brown bark | | Test Mat. | |
| | Vol. | Wt. | Vol. | | Vol. | Wt. | Vol. | | Vol. | | Vol. | |
| Item | Lts | Kg | Lts | Wt. Kg | Lts | Kg | Lts | Wt. Kg | Lts | Wt. Kg | Lts | Wt. Kg |
| Sheet | 0 | 0.00 | 348 | 189.55 | 348 | 81.59 | 696 | 233.27 | 696 | 199.05 | 203 | 334.13 |
| Value | | | | | | | | | | | | |
| Input | 0 | | 15.19 | | 15.19 | | 30.38 | | 30.38 | | 8.86 | |
| % Volume | | | | | | | | | | | | |
| Input | | 0 | | 18.27 | | 7.86 | | 22.48 | | 19.18 | | 32.20 |
| % Weight | | | | | | | | | | | | |

| | SOLID MATERIALS ADDED | | LIQUID | | | | | | |
|---|---|---|---|---|---|---|---|---|---|
| | CUMULATIVE | | ADDITIONS | | | ACTIVATOR | | PRODUCT | |
| | Vol. | | Leach. | Cond. | Fresh | | Vol. | Vol. | Wt. |
| Item | Lts | Wt. Kg | Vol. Lts | Vol. Lts | Vol. Lts | Desc | Lts | Lts | Kg |
| Sheet | 2291.00 | 1037.59 | 0 | 0 | 101.5 | | 11.6 | 1740 | 868.71 |
| Value | | | | | | | | | |
| Input | 100 | | | | | | | | |
| % Volume | | | | | | | | | |
| Input | 99.99 | | | | | | | | |
| % Weight | | | | | | | | | |

TABLE 5
Test Unit 01, Example 5

| | SOLID MATERIALS ADDED | | | | | | | | | | | |
|---|---|---|---|---|---|---|---|---|---|---|---|---|
| | | | | | | | Chipped | | | | | |
| | Fruit/Veg | | HenPen | | Green Waste | | Wood | | Test Mat. | | CUMULATIVE | |
| | Vol. | | Vol. | | Vol. | | Vol. | | | Wt. | Vol. | |
| Item | Lts | Wt. Kg | Lts | Wt. Kg | Lts | Wt. Kg | Lts | Wt. Kg | Vol. Lts | Kg | Lts | Wt. Kg |
| Sheet Value | 0 | 0.00 | 312 | 178.22 | 624 | 214.45 | 624 | 247.74 | 71.93 | 127.97 | 1631.93 | 768.38 |
| Input | 0 | | 19.12 | | 38.24 | | 38.24 | | 4.41 | | 100 | |
| % Volume | | | | | | | | | | | | |
| Input | | 0 | | 23.19 | | 27.91 | | 32.24 | | 16.65 | 99.99 | |
| % Weight | | | | | | | | | | | | |

| | LIQUID ADDITIONS | | | ACTIVATOR | | PRODUCT | |
|---|---|---|---|---|---|---|---|
| | Leach. | Cond. | Fresh | | Vol. | Vol. | |
| Item | Vol. Lts | Vol. Lts | Vol. Lts | Description | Lts | Lts | Wt. Kg |
| Sheet Value | 0 | 0 | 4 | RF | 5.4 | 1145 | 441.27 |
| Input | | | | | | | |
| % Volume | | | | | | | |
| Input | | | | | | | |
| % Weight | | | | | | | |

TABLE 6
Test Unit 02, Example 6

| | SOLID MATERIALS ADDED | | | | | | | | | | | |
|---|---|---|---|---|---|---|---|---|---|---|---|---|
| | | | | | | | Chipped | | | | | |
| | Fruit/Veg | | HenPen | | Green Waste | | Wood | | Test Mat. | | CUMULATIVE | |
| | Vol. | | Vol. | | Vol. | | Vol. | | | Wt. | Vol. | |
| Item | Lts | Wt. Kg | Lts | Wt. Kg | Lts | Wt. Kg | Lts | Wt. Kg | Vol. Lts | Kg | Lts | Wt. Kg |
| Sheet Value | 0 | 0 | 300 | 167.2 | 600 | 209.5 | 600 | 235.67 | 66.99 | 120.9 | 1567 | 733.32 |
| Input | 0 | | 19.14 | | 38.29 | | 38.29 | | 4.28 | | 100 | |
| % Volume | | | | | | | | | | | | |
| Input | | 0 | | 22.80 | | 28.57 | | 32.14 | | 16.49 | 100 | |
| % Weight | | | | | | | | | | | | |

| | LIQUID ADDITIONS | | | ACTIVATOR | | PRODUCT | |
|---|---|---|---|---|---|---|---|
| | Leach. | Cond. | Fresh | | Vol. | Vol. | |
| Item | Vol. Lts | Vol. Lts | Vol. Lts | Description | Lts | Lts | Wt. Kg |
| Sheet Value | 0 | 0 | 4 | RF | 5.2 | 992 | 379.8 |
| Input | | | | | | | |
| % Volume | | | | | | | |
| Input | | | | | | | |
| % Weight | | | | | | | |

TABLE 7
Test Unit 01, Example 7

| | SOLID MATERIALS ADDED | | | | | | | | | | | |
|---|---|---|---|---|---|---|---|---|---|---|---|---|
| | | | | | | | Chipped | | | | | |
| | Fruit/Veg | | HenPen | | Green Waste | | Wood | | Test Mat. | | CUMULATIVE | |
| | Vol. | | Vol. | | Vol. | | Vol. | | Vol. | | Vol. | |
| Item | Lts | Wt. Kg | Lts | Wt. Kg | Lts | Wt. Kg | Lts | Wt. Kg | Lts | Wt. Kg | Lts | Wt. Kg |
| Sheet Value | 0 | 0.00 | 420 | 214.62 | 1051 | 296.88 | 840 | 316.24 | 825.1 | 328.54 | 3136.08 | 1156.28 |
| Input | 0 | | 13.39 | | 33.51 | | 26.79 | | 26.31 | | 100 | |
| % Volume | | | | | | | | | | | | |
| Input | | 0 | | 18.56 | | 25.68 | | 27.35 | | 28.41 | 100 | |
| % Weight | | | | | | | | | | | | |

| | LIQUID ADDITIONS | | | ACTIVATOR | | PRODUCT | |
|---|---|---|---|---|---|---|---|
| | Leach. | Cond. | Fresh | | Vol. | Vol. | |
| Item | Vol. Lts | Vol. Lts | Vol. Lts | Description | Lts | Lts | Wt. Kg |
| Sheet Value | 0 | 68 | 0 | RF | 7 | 2031 | 770.32 |
| Input | | | | | | | |
| % Volume | | | | | | | |
| Input | | | | | | | |
| % Weight | | | | | | | |

TABLE 8
Test Unit 01, Example 8

| | SOLID MATERIALS ADDED | | | | | | | | | | | |
|---|---|---|---|---|---|---|---|---|---|---|---|---|
| | | | | | Chipped | | | | | | | |
| | HenPen | | Green Waste | | Wood | | Bark | | Test Mat. | | CUMULATIVE | |
| | Vol. | | Vol. | | Vol. | | Vol. | | Vol. | | Vol. | |
| Item | Lts | Wt. Kg | Lts | Wt. Kg | Lts | Wt. Kg | Lts | Wt. Kg | Lts | Wt. Kg | Lts | Wt. Kg |
| Sheet Value | 347 | 189 | 960 | 269 | 996 | 312 | 720 | 194 | 111 | 193 | 3129 | 1157 |
| Input | 11.1 | | 30.7 | | 31.8 | | 23 | | 3.54 | | 100 | |
| % Volume | | | | | | | | | | | | |
| Input | | 16.32 | | 23.26 | | 27.01 | | 16.7 | | 16.68 | 100 | |
| % Weight | | | | | | | | | | | | |

| | LIQUID ADDITIONS | | | ACTIVATOR | | PRODUCT | |
|---|---|---|---|---|---|---|---|
| | Leach. | Cond. | Fresh | | Vol. | Vol. | |
| Item | Vol. Lts | Vol. Lts | Vol. Lts | Description | Lts | Lts | Wt. Kg |
| Sheet Value | 0 | 0 | 217 | RF | 8.6 | 2790 | 1063 |
| Input | | | | | | | |
| % Volume | | | | | | | |
| Input | | | | | | | |
| % Weight | | | | | | | |

TABLE 9
Test Unit 02, Example 9

| | HenPen | | Green Waste | | Chipped Wood | | Test Mat. | | CUMULATIVE | |
|---|---|---|---|---|---|---|---|---|---|---|
| Item | Vol. Lts | Wt. Kg | Vol. Lts | Wt. Kg | Vol. Lts | Wt. Kg | Vol. Lts | Wt. Kg | Vol. Lts | Wt. Kg |
| Sheet | 456 | 241.8 | 1776 | 466.1 | 1752 | 481.5 | 1251 | 472 | 5235 | 1661 |
| Value | | | | | | | | | | |
| Input | 8.71 | | 33.92 | | 33.46 | | 23.9 | | 100 | |
| % Vol | | | | | | | | | | |
| Input | | 14.56 | | 28.05 | | 28.98 | | 28.41 | 100 | |
| % Wt | | | | | | | | | | |

| | LIQUID ADDITIONS | | | | | | |
|---|---|---|---|---|---|---|---|
| | Leach. | Cond. | Fresh | ACTIVATOR | | PRODUCT | |
| Item | Vol. Lts | Vol. Lts | Vol. Lts | Description | Vol. Lts | Vol. Lts | Wt. Kg |
| Sheet | 0 | 0 | 444 | RF | 12.6 | 4346 | 1442 |
| Value | | | | | | | |
| Input | | | | | | | |
| % Vol | | | | | | | |
| Input | | | | | | | |
| % Wt | | | | | | | |

TABLE 10

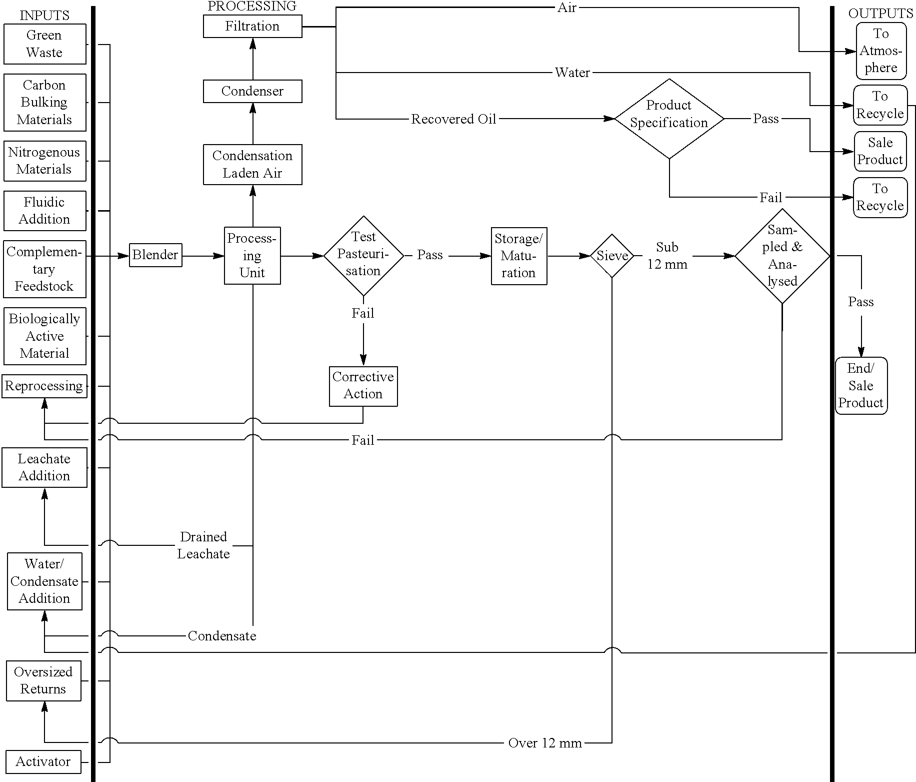

TABLE 11

| Example | Main Findings |
|---|---|
| 1 | 1. Heavy smell of cuttings on output material. |
| | 2. Extraction system being damaged by VOCs in air. |
| 2 | 1. Very heavy smell of cuttings on output material. |
| | 2. Extraction system damaged. |
| | 3. Anaerobic smell from unit. |
| | 4. Material mass over heated within process unit. |
| 3 | Smell of drill cuttings still from output material. |
| 4 | Heavy smell of cuttings on output material. |
| 5 | Formulation gave greatly improved analysis results. |
| 6 | Formulation gave greatly improved analysis results. |
| 7 | Formulation gave greatly improved analysis results. |
| 8 | Compost unit began to become inactive, possibly due to the |
| | summer temperatures drying out the input materials, and |
| | possibly leading to loss of microbial mobility. |
| 9 | Compost unit began to become inactive, possibly due to the |
| | summer temperatures drying out the input materials, and |
| | possibly leading to loss of microbial mobility. |

TABLE 12

Hydrocarbon Level
Improvement (%)

| Trial No | THC | Aromatics |
|---|---|---|
| 1 | 25.26 | 18.69 |
| 2 | 18.71 | 18.25 |
| 3 | 28.73 | 26.75 |
| 4 | 14.65 | 16.44 |
| 5 | 78.95 | 84.41 |
| 6 | 66.77 | 68.45 |
| 7 | 79.43 | 74.52 |
| 8 | 93.77 | 24.07 |
| 9 | 31.73 | 26.09 |

TABLE 13
Data from sequential growth trials using compost, blends and garden soil

| | Individual Crop Masses | | | | | Accumulative Crop Masses | | | | |
|---|---|---|---|---|---|---|---|---|---|---|
| | 1st | 2nd | 3rd | 4th | 5th | 1st | 2nd | 3rd | 4th | 5th |
| 100% | 20 | 19 | 10.25 | 56 | 98 | 20 | 39 | 49.25 | 105.25 | 203.25 |
| Compost | | | | | | | | | | |
| 50:50 | 116 | 53 | 45.25 | 47 | 170 | 116 | 169 | 214.25 | 261.25 | 431.25 |
| 25:75 | 92 | 31 | 23.75 | 27 | 108 | 92 | 123 | 146.75 | 173.75 | 281.75 |
| 100% Soil | 59 | 21 | 15.75 | 21 | 69.2 | 59 | 80 | 95.75 | 116.75 | 185.95 |

TABLE 14
1 REPORTED RESULTS AGAINST PAS 100 &
UK SOIL GUIDELINE VALUES (SGV)

| | | |
|---|---|---|
| Av. compost | RA trial sample | clea sgv |
| results (mg/kg) | (mg/kg) | (mg/kg) |

| | (fm. 5&6-11.2% | (initial solids | | residential (with | |
|---|---|---|---|---|---|
| Determinand | om) | 21% om) | PAS 100 | plant uptake) | commercial |
| Cd | 0.39 | <0.5 | 1.5 | 2 | 1,400 |
| Cr | 12.8 | 7.7 | 100 | 130 | 5,000 |
| Cu | 70.7 | 72 | 200 | N/A | N/A |
| Hg | 0.64 | <1 | 1 | 8 | 480 |
| Ni | 14 | 9.7 | 50 | 50 | 5,000 |
| Pb | 42.9 | 24 | 200 | 450 | 750 |
| Zn | 338 | 330 | 400 | N/A | N/A |

2 RESULTS CORRECTED TO 40% OM AGAINST
SEPA POSITION STATEMENT STANDARDS

| | Av. compost results | | |
|---|---|---|---|
| | (mg/kg) | | |
| | (corrected from | RA trial sample | |
| | 11.2 to 40% om) | (mg/kg) | |
| Determinand | (mg/kg) | (initial solids om = 38%) | sepa standard (mg/kg) |
| Cd | 0.26 | <0.5 | 3 |
| Cr | 8.7 | 7.5 | 400 |
| Cu | 47.8 | 70 | 200 |
| Hg | 0.43 | <1 | 1 |
| Ni | 9.5 | 9.4 | 100 |
| Pb | 29 | 23 | 200 |
| Zn | 228 | 319 | 1,000 |

3. RESULTS CORRECTED TO 30% OM AGAINST
DRAFT EU BIOWASTE STANDARDS

| | | RA trial sample | | | |
|---|---|---|---|---|---|
| | Av. compost results | (mg/kg) | EU biowaste standard (mg/kg) | | |
| | (corrected to 30% om) | (initial solids | | | st. |
| Determinand | (mg/kg) | om = 38%) | class i | class ii | blow. |
| Cd | 0.31 | <0.5 | 0.7 | 1.5 | 5 |
| Cr | 10.1 | 8.7 | 100 | 150 | 600 |
| Cu | 55.8 | 81 | 100 | 150 | 600 |
| Hg | 0.51 | <1 | 0.5 | 1 | 5 |
| Ni | 11.1 | 11 | 50 | 75 | 150 |
| Pb | 33.9 | 27 | 100 | 150 | 500 |
| Zn | 266 | 373 | 200 | 400 | 1500 |

TABLE 15

| | 100% | | | | | CLEA - SGV | |
|---|---|---|---|---|---|---|---|
| | Compost | 100% | | | SEPA | Residential. | |
| Determinand | (Adjusted to | Garden | 50% | 25% | Position | with Plant | |
| (mg/kg) | 40% OM) | Soil | Comp | Comp | Statement | Uptake | C & I |
| Cd | <0.5 | <0.5 | <0.5 | <0.5 | 3 | 2 | 1,400 |
| Cr | 7.7 | 36 | 32 | 25 | 400 | 130 | 5,000 |
| Cu | 72 | 30 | 32 | 31 | 200 | — | — |
| Hg | <1 | <0.2 | <0.2 | <0.2 | 1 | 8 | 480 |
| Ni | 9.7 | 23 | 19 | 20 | 100 | 50 | 5,000 |
| Pb | 24 | 53 | 46 | 37 | 200 | 450 | 750 |
| Zn | 330 | 110 | 110 | 130 | 1,000 | — | — |

TABLE 16
Uptake of PTEs by grasses grown on compost, blends and soil

| | Trial Sample | | | | | | | |
|---|---|---|---|---|---|---|---|---|
| | Grass | | | | | | | |
| | | | 50:50 | | 25:75 | | | |
| | 100% Comp | | Comp:Soil | | Comp:Soil | | 100% Soil | |
| DETERMINAND | Medium | Grass | Medium | Grass | Medium | Grass | Medium | Grass |
| As mg/kg | 2.2 | 0.08 | 10 | 0.07 | 7.9 | 0.06 | 12 | 0.13 |
| B mg/kg | 7 | 5.59 | 2.2 | 6.58 | 3 | 5.1 | 1.6 | 5.6 |
| Cd mg/kg | <0.5 | 0.03 | <0.5 | 0.02 | <0.5 | 0.02 | <0.5 | 0.03 |
| Cr mg/kg | 7.7 | 2.1 | 32 | 1.5 | 25 | 0.9 | 36 | 3.9 |
| Cu mg/kg | 72 | 5.3 | 32 | 12.2 | 31 | ND | 30 | 2.4 |
| Hg mg/kg | 0.21 | 0.05 | <0.02 | 0.05 | <0.02 | 0.07 | <0.02 | 0.06 |
| Ni mg/kg | 9.7 | 3.3 | 20 | 2.8 | 19 | 2.8 | 23 | 6.4 |
| Pb mg/kg | 24 | 1 | 46 | 2.2 | 37 | 0.3 | 53 | 0.8 |
| Zn mg/kg | 330 | 65.1 | 110 | 174.4 | 130 | 33.2 | 110 | 37.3 |

TABLE 17
Uptake of PTEs by grasses grown on blends, compost and soil

| | | | | | COMMON EU GUIDELINES | |
|---|---|---|---|---|---|---|
| | | | | | | HARVEST- |
| | GRASS GROWN on TRIAL COMPOST | | | | | RELATED |
| | | 50:50 | 25:75 | 100% | NORMAL | TOXICITY |
| PTE | 100% Comp | Comp:Soil | Comp:Soil | Soil | PLANT CONC. | LIMITS |
| Cd | 0.03 | 0.02 | 0.02 | 0.03 | 0.1-0.5 | 2.5-10 |
| mg/kg | | | | | | |
| Cr | 2.1 | 1.5 | 0.9 | 3.9 | 0.1-1 | 1-2 |
| mg/kg | | | | | | |
| Cu | 5.3 | 12.2 | ND | 2.4 | 2-20 | 15-20 |
| mg/kg | | | | | | |
| Hg | 0.05 | 0.05 | 0.07 | 0.06 | 0.003-0.086 | 0.5-1 |
| mg/kg | | | | | | |
| Ni | 3.3 | 2.8 | 2.8 | 6.4 | 0.1-2 | — |
| mg/kg | | | | | | |
| Pb | 1 | 2.2 | 0.3 | 0.8 | 0.1-10 | 10-20 |
| mg/kg | | | | | | |
| Zn | 65.1 | 174.4 | 33.2 | 37.3 | 2-100 | 150-200 |
| mg/kg | | | | | | |

TABLE 18
ELUATE AVERAGE RESULTS - BLENDS ANALYSES, COMPOST PRODUCT & GARDEN SOIL.

| | 100% Envireneer Comp. | | | | 100% Soil | | | | 50% Envireneer | | | |
|---|---|---|---|---|---|---|---|---|---|---|---|---|
| | Downflow | | Upflow | | Downflow | | Upflow | | Downflow | | Upflow | |
| | Start | Finish | Start | Finish | Start | Finish | Start | Finish | Start | Finish | Start | Finish |
| pH | 8.2 | 6.8 | 7.8 | 7 | 10 | 7.5 | 9.5 | 7.4 | 10 | 6.8 | 7.9 | 7.1 |
| SS mg/l | 1100 | 5.5 | 1400 | 160 | 230 | 3 | 260 | <2 | 720 | <2 | 1100 | 37 |
| E. Cond | 1600 | 5.5 | 1700 | 160 | 420 | 95 | 440 | 140 | 1200 | 290 | 670 | 170 |
| μS/cm | | | | | | | | | | | | |
| BOD | 325 | <2 | 245 | >18 | <2 | <2 | <2 | <2 | 71 | <2 | 140 | >20 |
| mg/l | | | | | | | | | | | | |
| Na mg/l | 195 | 3.9 | 200 | 6.2 | 4.2 | 0.65 | 52 | 0.83 | 104 | 1.4 | 100 | 3.5 |
| Fe mg/l | 0.45 | 0.36 | 0.39 | 0.21 | 0.5 | 0.07 | 0.22 | 0.42 | 0.43 | 0.56 | 0.5 | 1.8 |
| Mn mg/l | 0.35 | 0.051 | 0.3 | 0.53 | 0.03 | <0.01 | 0.043 | 0.38 | 0.01 | 0.11 | 0.32 | 0.84 |
| SO4 mg/l | 120 | <24 | 150 | <24 | 24 | <24 | <24 | <24 | 160 | <24 | 150 | <24 |
| Cd mg/l | <0.002 | <0.002 | <0.002 | <0.002 | <0.002 | <0.002 | <0.002 | <0.002 | <0.002 | <0.002 | <0.002 | <0.002 |
| Cr mg/l | <0.01 | <0.01 | <0.01 | <0.01 | <0.01 | <0.01 | <0.01 | <0.01 | <0.01 | <0.01 | <0.01 | <0.01 |
| Cu mg/l | 0.16 | 0.015 | 0.17 | 0.025 | 0.05 | 0.012 | 0.014 | <0.01 | 0.08 | 0.011 | 0.08 | 0.013 |
| Hg mg/l | <0.001 | <0.001 | <0.001 | <0.001 | <0.001 | <0.001 | <0.001 | <0.001 | <0.001 | <0.001 | <0.001 | <0.001 |
| Ni mg/l | 0.024 | <0.02 | 0.031 | <0.02 | <0.02 | <0.02 | <0.02 | <0.02 | 0.022 | <0.02 | <0.02 | <0.02 |
| Pb mg/l | <0.05 | <0.05 | <0.05 | <0.05 | <0.05 | <0.05 | <0.05 | <0.05 | <0.05 | <0.05 | <0.05 | <0.05 |
| Zn mg/l | 0.027 | 0.055 | 0.22 | 0.16 | 0.05 | 0.03 | 0.01 | 0.02 | 0.13 | 0.05 | 0.11 | 0.08 |
| NH3—N | 17 | <0.02 | 19 | 11 | 0.21 | <0.02 | <0.02 | 0.4 | <0.02 | <0.02 | 0.98 | 7 |
| mg/l | | | | | | | | | | | | |
| N03—N | <2.2 | 22.2 | <2.2 | <2.2 | <2.2 | 11 | <2.2 | <2.2 | <2.2 | <2.2 | <2.2 | <2.2 |
| mg/l | | | | | | | | | | | | |

| | 25% Envireneer | | | | | |
|---|---|---|---|---|---|---|
| | Downflow | | Upflow | | | |
| | Start | Finish | Start | Finish | Drinking Water | DWI Standard |
| pH | 9.5 | 7 | 9.2 | 7.2 | 6.5-10 | 5.5-9.5 |
| SS mg/l | 640 | <2 | 650 | 34 | | |
| E. Cond | 440 | 250 | 470 | 150 | 2,500* | |
| μS/cm | | | | | | |
| BOD | 57 | <2 | 41 | >20 | | |
| mg/l | | | | | | |
| Na mg/l | 60 | 2.5 | 60 | 2 | 0.2* | 150 |
| Fe mg/l | 0.4 | 0.12 | 0.43 | 2.8 | 0.2 | 0.2 |
| Mn mg/l | 0.18 | 0.12 | 0.14 | 1.3 | 0.05 | 0.05 |
| SO4 mg/l | 120 | <24 | 140 | <24 | 250* | 250 |
| Cd mg/l | <0.002 | <0.002 | <0.002 | <0.002 | 0.005 | 0.005 |
| Cr mg/l | <0.01 | <0.01 | <0.01 | <0.01 | 0.05 | 0.05 |
| Cu mg/l | 0.04 | 0.012 | 0.04 | <0.01 | 2 | 3 |
| Hg mg/l | <0.001 | <0.001 | <0.001 | <0.001 | 0.001 | 0.001 |
| Ni mg/l | <0.02 | <0.02 | <0.02 | <0.02 | 0.02 | 0.05 |
| Pb mg/l | <0.05 | <0.05 | <0.05 | <0.05 | 0.025/0.01 | 0.05 |
| Zn mg/l | 0.07 | 0.04 | 0.06 | 0.05 | | 5 |
| NH3—N | <0.02 | <0.02 | 2.1 | 5.1 | 0.5 | 0.5 |
| mg/l | | | | | | |
| N03—N | 40 | <2.2 | <2.2 | <2.2 | 60 | 60 |
| mg/l | | | | | | |

*Italics are Schedule 2 - Indicator parameters; all values quoted as soluble concentration

1. A method for the treatment of oil and/or gas field waste and by product materials, the method comprising composting the waste materials, wherein the composting operation is carried out in a composting chamber, the composting chamber incorporating a tilling device to move the materials, and wherein the tilling device is rotated intermittently during the composting process.

2-4. (canceled)

5. A method as claimed in claim 1, wherein the composting chamber is cylindrical and wherein the tilling device has blades that extend across substantially the whole diameter of the cylindrical chamber.

6. A method as claimed in claim 5, wherein the cylindrical chamber has an axis, and wherein during the method the axis is oriented upwards so that the materials being composted fall to the bottom of the cylindrical chamber and are lifted by the tilling device toward the top of the cylindrical chamber.

7-9. (canceled)

10. A method as claimed in claim 1 wherein the tilling device is a rotary auger.

11. A method as claimed in claim 1, wherein the composting chamber has an axis, an inlet and an outlet, and wherein the axis between the inlet and the outlet is tilted with respect to the horizontal during the method.

12. (canceled)

13. A method as claimed in claim 1, wherein the chamber has a rectangular cross section.

14. (canceled)

15. A method as claimed in claim 1, wherein the waste and by-product materials are contaminated by organic compounds.

16. A method as claimed in claim 15, wherein the organic compounds are selected from the group consisting of hydrocarbons, oil, water or synthetic based drilling muds, and production fluids from the well.

17. A method as claimed in claim 1, wherein the waste and by-product materials are contaminated by inorganic compounds.

18. A method as claimed in claim 17, wherein the inorganic compounds comprise sulphates, chlorides, formates or heavy metals.

19. A method as claimed in claim 1, wherein waste materials selected from the group consisting of biological waste, animal waste and food wastes are added to the composting chamber along with the oil or gas field waste or by product materials.

20. A method as claimed in claim 1, wherein the composting involves an endogenous microbial population on the composted mixture.

21. A method as claimed in claim 1, wherein the materials being treated are mixed with a feeder material to provide nitrogen and/or carbon sources for the microbes.

22. A method as claimed in claim 21, wherein the feeder material comprises feeder material that is high in carbon sources.

23. A method as claimed in claim 21, wherein the feeder material comprises fruit or vegetable waste.

24. A method as claimed in claim 21, wherein the material being treated is mixed with feeder material that is high in nitrogen sources.

25. A method as claimed in claim 21, wherein the feeder material is selected from the group consisting of plant waste, leaves, grass and plant cuttings, bark, twigs, sawdust, wood shavings, chipped wood, shredded paper, cardboard, animal bedding and fish waste.

26. A method as claimed in claim 1, wherein the waste products are hydrocarbon-contaminated waste products containing carbon residues with chain lengths exceeding five carbon atoms.

27. A method as claimed in claim 1, wherein an exogenous source of microbes is added to the composting mix in order to degrade particular contaminants on the waste or by-product material.

28. A method as claimed in claim 1, wherein the carbon and nitrogen composition of the feeder material is manipulated to boost the microbial population in order to achieve a population suitable for effective degradation of hydrocarbon contaminants present on the waste material being treated.

29. A method as claimed in claim 1, wherein the carbon and nitrogen composition of the feeder material is manipulated throughout the composting operation to control the available amounts of carbon from the feeder material and the waste materials.

30. A method as claimed in claim 1, wherein the composting process is carried out at between 40 C and 80 C.

31. A method as claimed in claim 1, wherein the composting process is carried out at between 50 C and 75 C.

32. A method as claimed in claim 1, wherein the temperature of the materials being composted is controlled by heating and cooling units in the composting chamber to maintain the temperature within a range that is beneficial for the microbial population being used in the process.

33. A method as claimed in claim 1, wherein the material being treated comprises drill cuttings.

34. A method of producing compost, the method comprising adding oil and/or gas field waste materials to a composting mixture so that the microbial population in the composting mixture degrades metabolic substrates from the oil and/or gas field waste materials.

35. A method as claimed in claim 34 wherein the material being treated includes an activator comprising a mixture of amino acids and nutrients to serve as precursors for use in the metabolic pathways employed by the microbial population.

36. A method as claimed in claim 1, wherein materials treated by the method and recovered from the composting mixture are treated at least once more by the method.

37. A method as claimed in claim 36, wherein the materials recovered from the composting mixture and treated at least once more comprise leachate and distillate fluids, which are re-introduced into the same or a different composting mixture after recovery.

38. A method as claimed in claim 21, wherein liquid is removed from the composting reaction, and wherein the volume of liquid removed from the composting reaction is measured, and the quantity of feeder material within the reaction is adjusted, the rate of turning is adjusted, and/or the amount of oversized materials or fluids present in the mixture is adjusted, in accordance with the volume of liquid condensed from the composting reaction.

39. A method as claimed in claim 1, wherein bulky materials are added to the composting mixture to enhance the aeration of the mixture.

40. A method as claimed in claim 1, wherein compressed gas is injected into the composting mixture during the process.

41. A method as claimed in claim 40 wherein the compressed gas is warmed or cooled before injection.

42. A method as claimed in claim 1, wherein additional contaminating hydrocarbons are added into the composting mixture in order to increase the available carbon sources for growth of the microbial population.

43. A method as claimed in claim 1, wherein treated material is left in a maturation pile for fungi to establish and break down complex hydrocarbon residues.

44. A method as claimed in claim 1, wherein the process is continued until the output material comprises 5 percent (50,000 ppm) or less total hydrocarbon content (THC).

45. A method as claimed in claim 1, wherein the process is continued until the output material comprises 2 percent (20,000 ppm) or less THC.

46. A method as claimed in claim 1, wherein the process is continued until the output material comprises 0.1 percent (1,000 ppm) or less THC.

47. A method as claimed in claim 1 wherein sufficient material is treated within the composting chamber such that the composting reaction reaches a point of critical mass.

48. A method as claimed in claim 1, wherein the composting reaction is self-sustaining.
